(19) United States
(12) Patent Application Publication
(10) Pub. No.: US 2002/0162108 A1
(43) Pub. Date: Oct. 31, 2002

(54) Interactive/ active electronic program/ content guide (IAEPG) with computer enhanced, web-wrapped user interfaces, programablility, and automated search, record, and present

(76) Inventor: Catherine Lin-Hendel, Los Gatos, CA (US)

Correspondence Address: ZIMMERMAN & LEVI, L.L.P., INTELLECTUAL PROPERTY ATTORNEYS, 226 ST. PAUL STREET, WESTFIELD, NJ, 07090, US

(21) Appl. No.: 10/079,395

(22) Filed: Feb. 19, 2002

Related U.S. Application Data
(60) Provisional application No. 60/280,580, filed on Mar. 30, 2001.

(51) Int. Cl. H04N 5/445; G06F 3/00; G06F 13/00

(52) U.S. Cl. 725/52

(57) ABSTRACT

An electronic program guide (EPG) having a grid-guide menu and multiple-level nested cascading menus, each cascading menu is adapted to be overlaid upon a current page of the grid-guide menu. During navigation, within a selected multiple-level nested cascading menu, a nested, cascading category-tree of submenus appear and are overlaid upon the current page of the grid-guide menu, until the nested, cascading category-tree is exhausted. A remote control device permits navigating within the grid-guide menu and the multiple-level nested cascading menus. Additionally, the remote control interacts with the EPG to effectuate multiple program selections during the current grid-guide menu during a single selection sequence.

### CROSS REFERENCE TO RELATED APPLICATIONS

This application claims priority from the U.S. Provisional Patent Application Serial No. 06/280,580 filed on Mar. 30, 2001.

### FIELD OF THE INVENTION

This present invention relates to interactive/active electronic program/content guides (IAEPG) for interactive television/broadcast/cable systems, and in general, systems that list, present, and distribute media, products, services, and information (henceforth, the above will be abbreviated as MEDIA). More particularly the present invention uses microprocessor(s), memory devices, communications controllers, storage devices/disks, a display device, output/signaling devices, and a multitude of input devices to enable intelligent, user friendly, and multi-tasking interface to the MEDIA. The present invention provides superior user interfaces, enhanced interactivity, simpler user processes, and apparatus such as electronic file folders to record, organize, and retrieve user preferences and profiles for multiple users. The present invention actively/automatically browses, probes, filters, and picks-up relevant content (CONTENT) from MEDIA, according to user specification/preferences/profile stored and activated for such automated probe and pick-up. Furthermore, the user interface of the present invention includes virtual-buttons or cells wherein at least one button or cell includes a programmable multi-level, nested cascading menu.

### BACKGROUND OF THE INVENTION

The conventional interactive electronic TV program guides include a control device 10 (FIG. 1) and program listing presented in a grid format (FIG. 2) on a TV display screen in single-level and single-choice channel (y-axis)-time (x-axis) grid menu 20. Only one single menu can be presented at any one time, and only one choice out of the menu can be selected and processed.

The control device 10 had a multitude of control buttons to enable a viewer to move or shift a “cursor” (represented by high-lighting or distinctive coloring) on the TV screen grid, one-cell-at-a-time to reach the “interested” menu-item on the grid-guide menu 20. Pressing the “MENU/SELECT” button 12 on the control device 10, while one particular cell is highlighted, would refresh the entire display screen. Additionally, it would bring a program, a program list, or the next single-level menu associated with that selected/highlighted menu-item on the previous screen onto the present display screen, as dictated by the selected menu-item of the previous screen. Due to the limited screen space, items on the menu are listed in cryptic nomenclature, without means to describe to the viewer (a) what each menu item represents; (b) what are the options; and (c) what will be fetched and brought to the display screen, when the “MENU/SELECT” button 12 is pressed on the control device 10. When the “MENU/SELECT” button 12 is pressed and the resulting information is not what the viewer had anticipated or desired, the viewer must return to the start-up page and retrace steps one-selection-at-a-time and one-screen-at-a-time to reach the screen where the mistaken selection was made, in order to explore other options from that branching point (FIGS. 2-6).

Recent inventions sought to bypass the elaborate procedure of using the remote control device 10 to look for and select a particular “theme” on the conventional TV EPG screen. These inventions proposes to add to TV remote control devices a limited set of THEME buttons, each relating to a particular type of TV programs, such as MOVIES, MUSIC, NEWS, SPORTS, and KIDS. By pressing a particular THEME (e.g. NEWS) button on such proposed remote control device, channels programmed into that “THEME” button will be listed on the TV display screen in the conventional TV EPG channel-time grid format. Since the remote control device has a certain practical size limitation, there can only be a small number of such “THEME” buttons on the device. The single-screen nature of the conventional TV EPG dictates a very limited display capacity, thus further dictates that the representations of menu items to be cryptic, and as a result, difficult to understand. There is no way to confirm each particular menu-item representation, other than highlighting that particular menu-item by repeatedly pressing the arrow keys 17 on the remote control device 10 in FIG. 1, and then pressing the “MENU/SELECT” button 12 to see what actually happens on the TV display screen. A user typically interprets indirectly which cryptic representation, among many, might be what the user wants to see, and then executes the highlighting-and-select procedure described above, in hopes of getting what the user wants. As can be appreciated, this requires repeated pressing of arrow keys 17, MENU/SELECT button 12 and going back and forth to reach what programs/information the user intends to reach.

Since the user can only select one single item listed, in order to select multiple programs to be recorded by a VCR, the user must repeat such elaborate “guess work” process, at a minimal, as many times as the number of programs to be recorded. In view of the above, presently, the conventional TV EPG is difficult to navigate, and the programming procedures of the conventional TV EPG are awkward, often requiring the user to key in the exact channel numbers for VCR recording purposes.

Furthermore, the increasingly massive availability of MEDIA, and specifically the number of TV channels and programs is making the conventional manual approach in browsing and selecting MEDIA/TV programs ever more difficult and time consuming. The present invention seeks to automate the browsing and selecting functions by using the increasingly more powerful electronic computing and storage devices to intercept the MEDIA for the viewers.

### SUMMARY OF THE INVENTION

The present invention contemplates an interactive media intercept computing and communication system having an interactive electronic content guide displayed on a display, the guide has a grid-guide menu identifying broadcast content or programs and at least one multiple-level nested cascading menu adapted to be overlaid upon a current page of the grid-guide menu. During navigation, within the at least one multiple-level nested cascading menu, a nested, cascading category-tree of submenus appear and are overlaid upon the current page of the grid-guide menu, until the nested, cascading category-tree is exhausted.

The system functions to intercept multiple programs selected from a single grid-guide menu during a single selection sequence for recording, later viewing on demand or later review of selections.

The present invention allows multiple users to program and store multiple selections/preferences/profiles in electronic directory, folders and files for later access, review, view-on-demand. These selection/preference/profile folders and files can be used to activate automated filtering/retrieval of specific CONTENT from MEDIA for recording, presentation, or purchase.

The present invention contemplates a new remote control device that includes the following new features beyond the conventional remote control: (1) a rollball to move the cursor on the display screen to a desired cell in a direct shortest-path motion, in addition to, or in place of the four arrow keys of a conventional remote control device; and, (2) alphanumeric buttons that facilitate alphabetic and numeric entries via the control device.

The present invention further contemplates an onscreen virtual remote control device similar to a new hand-held remote control device.

### BRIEF DESCRIPTION OF THE DRAWINGS

FIG. 1 illustrates a conventional remote control device for use with a conventional grid-format electronic programming guide (EPG).

FIG. 2 illustrates a conventional grid format TV EPG having a single-level, single-choice grid-guide menu, as displayed on the TV screen.

FIG. 3 illustrates a program sorting/listing menu page of a conventional TV EPG as displayed on the TV screen.

FIG. 4 illustrates a “theme” menu page of a conventional TV EPG as displayed on the TV screen.

FIG. 5 illustrates a conventional single-level and single-choice “movies” program listing menu page in a conventional TV EPG.

FIG. 6 illustrates the theme options menu of a conventional TV EPG.

FIG. 7 illustrates a MEDIA intercept system in accordance with the present invention.

FIG. 8A illustrates an exemplary implementation of the interactive/active electronic program/content guide (IAEPG) in accordance with the present invention for the TV environment.

FIG. 8B illustrates the “TIME” pull-down menu in accordance with the present invention.

FIG. 8C illustrates the on-demand annotation for the term “NORMAL” and all available options in parallel with the option “NORMAL.”

FIG. 8D illustrates an alternate embodiment that substitutes advertisement, promotions, news, etc. for the background program listing when the “TIME” pull-down menu is displayed.

FIG. 9 illustrates the “THEME” multi-level, nested cascading menu of the present invention.

FIG. 10 illustrates the “THEME” multi-level, nested cascading menu with an added Comedy folder.

FIG. 11 illustrates the “THEME” multi-level, nested cascading menu with a deleted Comedy folder.

FIG. 12 illustrates an exemplary “SELECTION FOLDERS” multi-level, nested cascading menu of the present invention.

FIG. 13 illustrates a user specified program listing that lists the Comedy2 programs profiled in the Comedy2 folder, during This Week with multiple cells highlighted for selection.

FIG. 14A illustrates the hand-held control device in accordance with the present invention for use with the IAEPG grid-guide menu of the present invention.

FIG. 14B illustrates a virtual on-screen control device that can be used as the control device on the screen of the display with a mouse, a point-and-click device, a screen pen, or a light pen input device.

FIGS. 15A-15C illustrate an exemplary programming sequence for creating a folder.

### DETAILED EMBODIMENT OF THE INVENTION

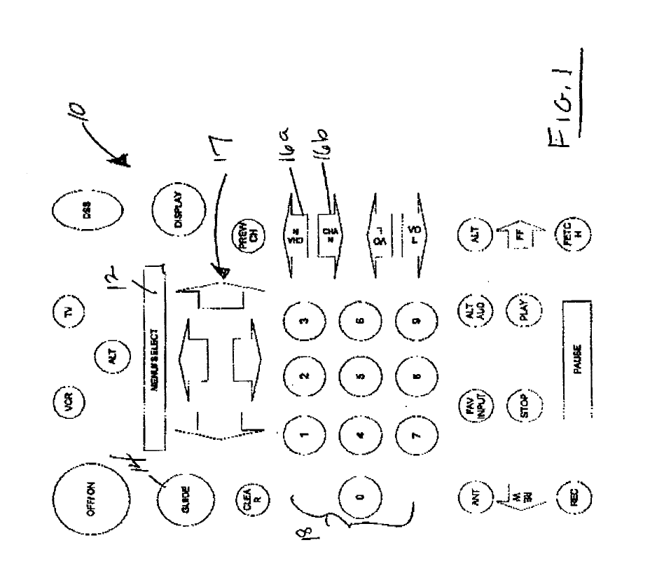

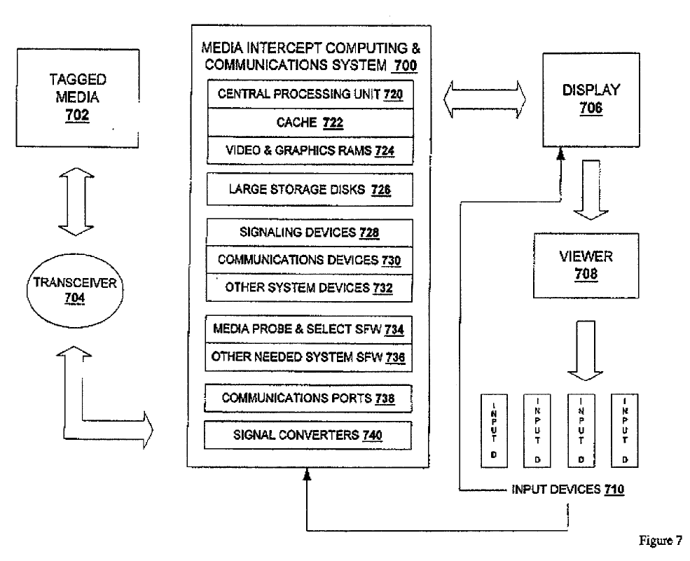

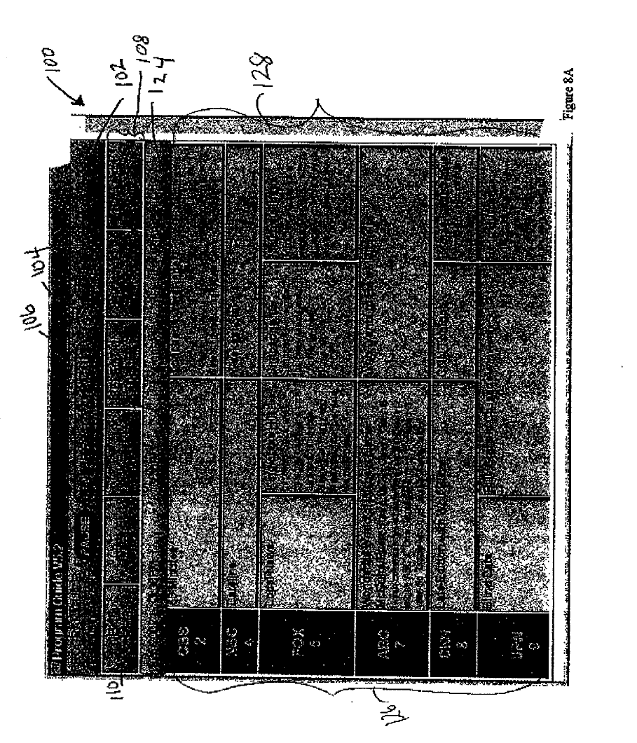

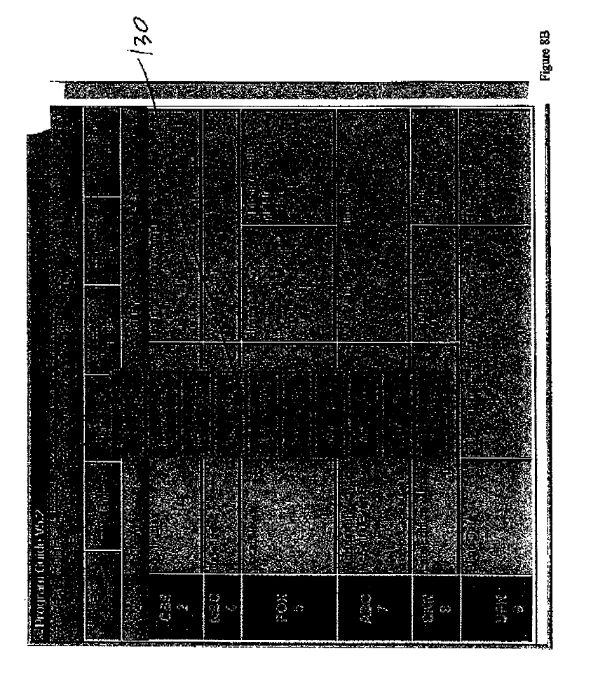

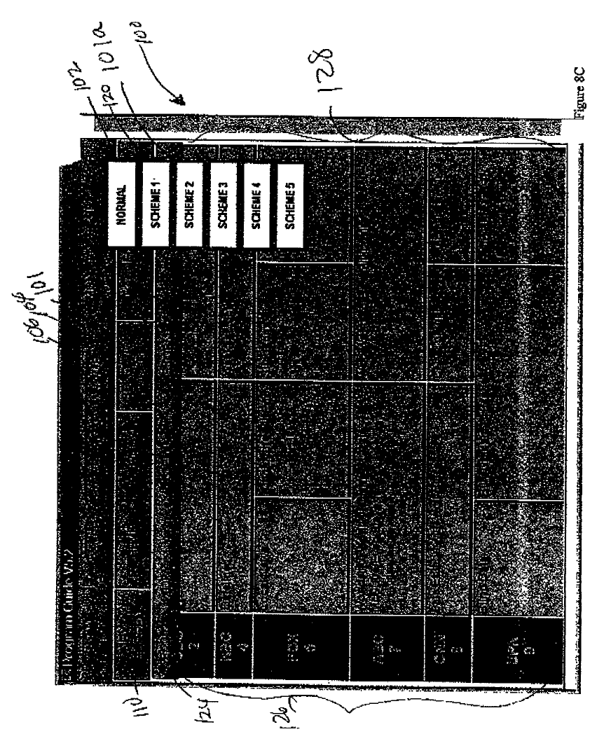

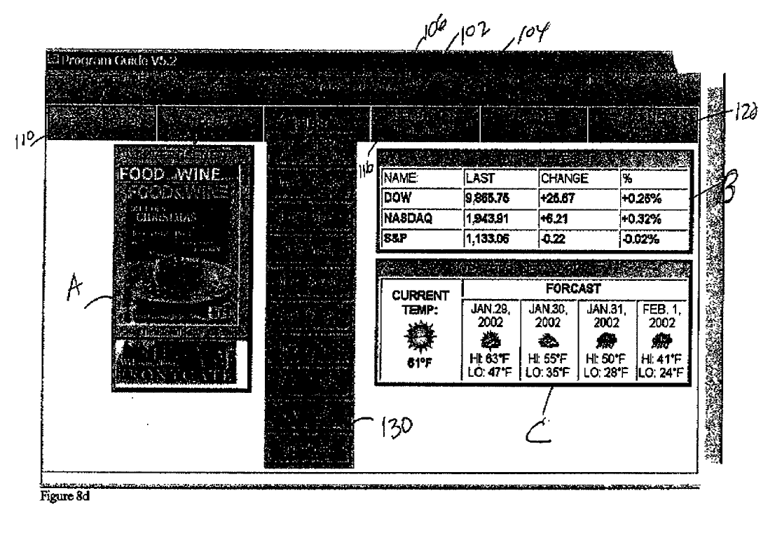

FIGS. 1 through 6 depicts the workings of a conventional TV EPG. In order that the details of the present invention can be appreciated in the context of the conventional TV EPG, FIGS. 1 through 6 will be briefly described. Then, FIGS. 7, 8A-D, 9-13, 14A-B and 15A-C, which depict examples of the present invention, will be described in detail.

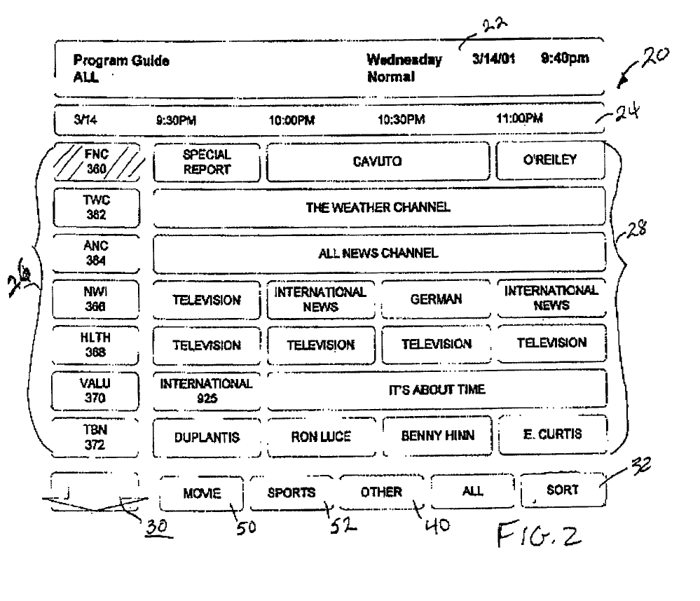

Referring now to FIG. 1, a conventional remote control device 10 for use with a conventional Electronic Program Guide (EPG) is illustrated. The “Guide” button 14 brings the single-level and single-choice channel-time grid-format program listing 20 onto the TV display screen, as shown in FIG. 2. The program listing 20 contains a “highlight,” a distinctive color overlaying the first listed channel (FNC 360) on the program listing 20. The “highlight” functions as a kind of a “cursor,” which can be shifted or moved from one cell to the immediate next cell, by pressing once one of the four arrow keys 17. Each of the four arrow keys 17 moves or shifts the “highlight” cursor one cell in the direction indicated by the arrow key, when pressed once. When the highlight-cursor reaches a desired selection, pressing the “MENU/SELECT” button 12 brings the content indicated by the selection to the TV display screen.

The “CHAN” up-down arrow buttons 16a, 16b on the right side of the control device 10, bring the previous-page or next-page program listing for the immediate previous or next group of channels. The numeric buttons 18 let a user enter a channel number. Pressing the “Guide” button 14 after entering a channel number via numeric buttons 18, brings the page of the program listing starting with the entered channel number. Pressing the “MENU/SELECT” button 12 immediately after entering a channel number via numeric buttons 18 would display the program that is currently played on that channel.

Referring now to FIG. 2, the first horizontal row 22 indicates the current time and the program-listing mode. The second horizontal row 24 indicates the current date and a 2-hour period in 4 segments. The first vertical column 26 indicates in sequence the channel numbers and the corresponding channel name. The program title cells 28 indicate the program names that are played at the corresponding times as indicated by the second horizontal row 24 and on the corresponding channels as indicated by the first column 26.

When the cursor—the color highlight, is shifted one-cell-at-a-time, to a specific program, and then the “MENU/SELECT” button 12 on the control device 10 is pressed, the program is retrieved from the broadcast stream, and displayed on the TV display screen. When the cursor is shifted to the “down arrow” 30 at the lower left corner of the guide-menu 20 and the “MENU/SELECT” button 12 on the control device 10 is pressed, the guide-menu 20 displays the program listing beginning with the next-channel down from the previous first channel shown on the previous listing, to include one additional channel with the next higher channel number to the last channel shown on the previous listing.

The “Movie” and “Sports” boxes 50 and 52 at the bottom row of the guide menu 20 allow the user to effectuate listing of all movie programs or all sports programs, respectively. The listing is displayed with a number of channels on one page at a time, and can be advanced by selecting the “down arrow” 30 on the guide menu 20 and pressing the “MENU/SELECT” button 12, one-channel-at-a-time, or “paged”—one-screenful-at-a-time back and forth through pressing the “up” or “down” CHAN buttons 16a and 16b.

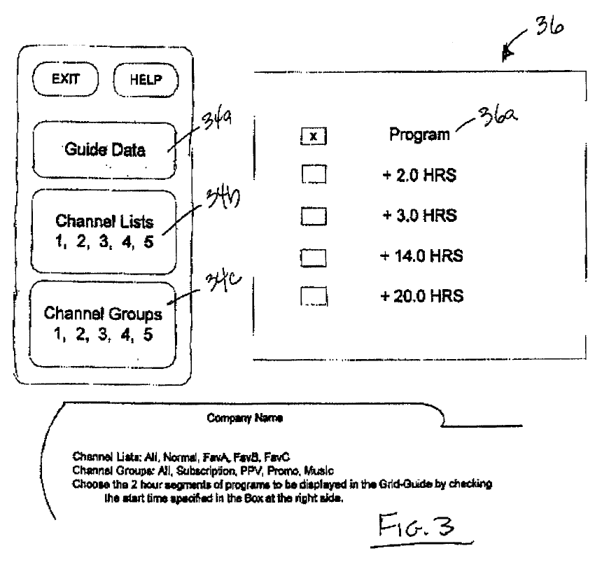

FIG. 3 illustrates a program sorting/listing menu page of a conventional TV EPG as displayed on the TV screen. The menu page is displayed on the TV screen when the SORT box 32 position on FIG. 2 is selected by shifting the highlight to SORT box 32 using the four arrow keys 17, and then pressing the MENU/SELECT button 12 of the remote control device 10.

The SORT box 32 at the lower right corner contains the link to a grid-guide listing of the program sorting/listing menu page as shown in FIG. 3. The sort/listing menu page as shown in this drawing defaults to highlight the first channel sorting option, the Guide Data 34a, which indicates “Data” provided by the “Guide” itself—all channels and all programs.

The default time sorting option menu 36 displays “Program” 36a and is indicated as checked. When “Program” 36a is checked, it indicates the time period of the present time to 2 hours from the present time. The combination of these two default selections indicates a sequential listing of all channels, and programs shown in each corresponding channel from the present time through the next two hours. The Channel Lists 34b indicates 5 reserve options (All 1, Normal 2, Fav A 3, Fav B 4, Fav C 5) that maybe provided in the future by the EPG, but is presently non-functioning. The Channel Groups 34c indicates 5 options for grouping channels (“All” programs, “Subscription” only programs, Pay Per View (PPV) programs, Promotional (Promo) Programs, and “Music” Programs). These numerically indicated options in the channel lists and groups 34b and 34c, as well as, the Guide Data 34a can only be figured out by selecting/highlighting the option, and press the Menu/Select button 12 on the remote control device 10, and see for oneself what program listing is brought to the TV screen.

The times indicated in the time sorting option menu 36 indicates the “start time” of listing. For example, if a user wishes to see the listing of available music programs beginning 3 hours from the present time, and ending 5 hours from the present time, the user would move the highlight cursor to 5 of the channel groups 34c, then check-mark the “+3.0 hrs” in the time sorting option menu 36, and then press the Menu/Select button 12 on the remote control device 10.

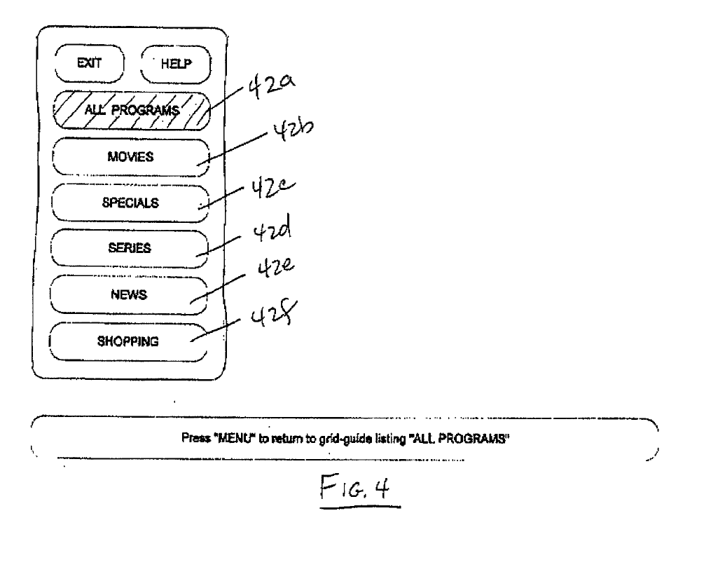

FIG. 4 illustrates an “other” menu page of a conventional TV EFG as displayed on the TV screen. The menu page is displayed on the TV screen when the highlight in FIG. 2 is shifted onto the OTHER box 40 position by using the four shift keys 17, and then pressing the MENU/SELECT 12 button on the remote control device 10.

The “OTHER” box 40 on the bottom row of the guide-menu 20 in FIG. 2 contains the link to the only theme-menu page the viewer can reach at this level. Shifting the cursor to highlight the “OTHER” box 40 in FIG. 2, and then pressing the MENU/SELECT button 12, the theme-menu page is brought forth to the TV display screen, as best seen in FIG. 4.

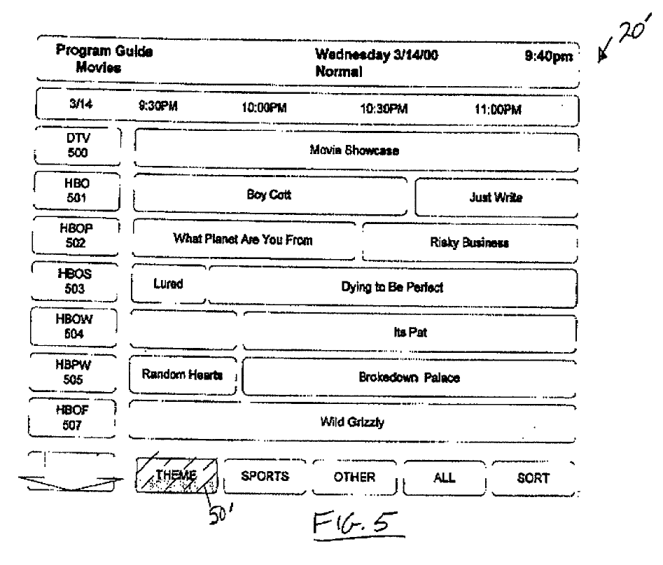

Referring still to FIG. 4, the default highlight is at the ALL PROGRAMS 42a, to indicate the previous program listing lists all programs. When the highlight is shifted to MOVIES 42b, and the MENU/SELECT button 12 on the remote control device 10 (FIG. 1) is pressed, the EPG transitions to a program listing which lists only movie channels, as shown in FIG. 5. Furthermore, in addition to the MOVIES 42b, the user has the option to select “Specials” button 42c, “Series” button 42d, “News” button 42e and “Shopping” button 42f to request the list of channels and programs of corresponding classifications.

Referring now to FIG. 5, an alternate single-level and single-choice grid-guide menu 20′ is shown. Menu 20′ lists the movie programs, as specified in FIG. 4. Moreover, the “THEME” button 50′ is substituted for the “MOVIE” button 50 in FIG. 2, while no indication exists to indicate that the current listing is of MOVIE channels.

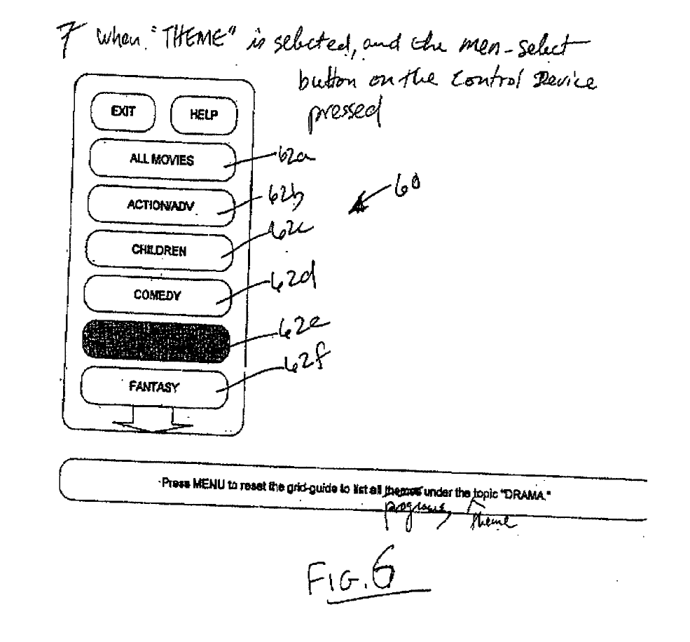

Referring now to FIG. 6, when the “THEME” button 50′ in FIG. 5 is highlighted, and then the “MENU/SELECT” button 12 is pressed, a theme-menu 60 is shown. The theme-menu 60 includes an “All Movies” button 62a, “ACTION/ADV” (to mean “adventure”) button 62b, “CHILDREN” button 62c, “COMEDY” button 62d, “DRAMA” button 62e and “FANTASY” button 62f. When the highlight-cursor is moved and any one of the buttons by pressing the arrow keys 17 on remote control device 10, such as to the “DRAMA” button 62e, the button is highlighted and the particular menu-item/category (e.g. DRAMA 62e) is selected. Thereafter, selecting the “MENU/SELECT” button 12 will reset the program listing 20′ to list all programs under the theme topic “DRAMA” or of other highlighted/selected menu-item/category.

Referring now to FIG. 7, the MEDIA intercept computing and communications system 700 is shown. The MEDIA intercept computing and communications system 700 employs electronic computing, communications, storage devices, and software to intercept broadcast MEDIA or CONTENT to list, present and distribute scheduled programming, products, services, information, and directory services to the users/viewers of the MEDIA. The MEDIA intercept computing and communications system 700 provides an interactive and active electronic content guide (IAEPG) that is intelligence, interactive, programmable, and having a far superior user interface. The IAEPG provides an electronic directory and file structure to store user specific preferences, selections, and profiles. Furthermore, the invention can be used to probe, filter, select, store and present relevant MEDIA to a user or a multitude of users according to user-programmed preferences/profiles and selections stored in electronic file folders.

It is preferable that the MEDIA 702 contents are tagged with keywords to specify each content's theme and/or other classification keywords. Otherwise, intelligent software can be used to read a part of a specific content, and prescribe tags/classifications to that content. The key elements of the electronic MEDIA intercept computing and communications system 700 includes and a transceiver 704. System 700 further includes the central processing unit 720, cache memory 722, video and graphics RAMs 724, large system storage devices (or disks and disk drives) 726, signaling devices 728, communications devices 730, the media probe & select software 734 that includes the IAEPG software, other system operating software 736, and other system operating devices 732, as well as communications ports 738, and signal converters 740. The display 706 receives the desired MEDIA content from the MEDIA intercept computing and communications system 700. A viewer's program and control system 708 is provided and is controlled through at least one of multitude of input devices 710, and/or the virtual on-screen control device 200 displayed on the screen of the display 706.

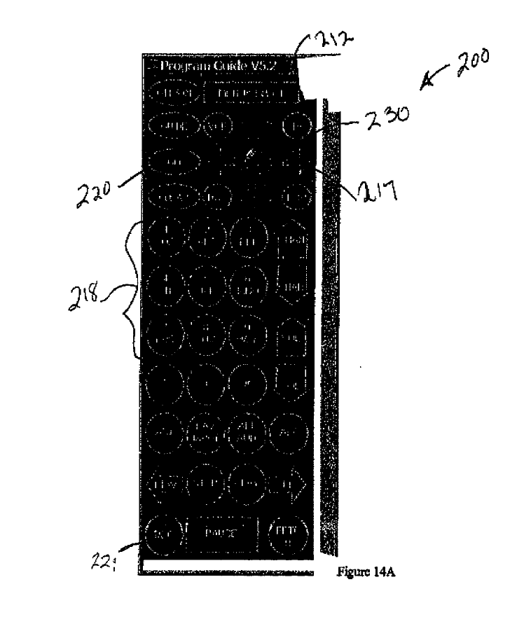

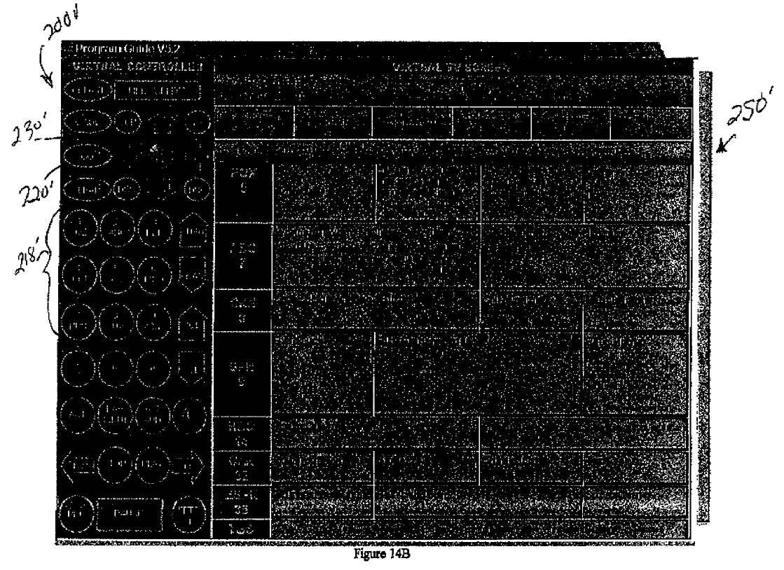

In operation, the MEDIA 702 is received via transceiver 704, and analog signals are converted to appropriate digital format through signal converter 740. The MEDIA probe & select software 734 exams the digital media stream for desired tags, and then records/stores such data that contains the desired tags into the large system storage disks 726. Upon viewer request, either preprogrammed, or in real-time through input devices 710 or the virtual onscreen control device 200′ (FIG. 14B), system 700 sends the recorded/stored content from storage disks 726 to display 706. In the case where the MEDIA is not tagged, an intelligent system (NOT SHOWN) must be included in the front end of MEDIA probe & select software 734 to partially read, and tag the digital media stream before making selections.

As can be appreciated, display 706 may be a TV screen of a TV, a computer display, a Kiosk display, cell-phones or other electronic display terminals. System 700 may be integrated into or interfaced with a TV, a computer, such as a personal computer, or the like. Broadcast MEDIA and CONTENT may be wired or wireless via cable systems, satellite systems, broadcast TV and the Internet.

Referring now to FIG. 14A, the hand-held remote control device 200 for use with the present invention adds a “GO” button 220, and a roll-ball “mouse” device 230 that moves the highlight-cursor in any and all desired direction, in contrast to the cell-by-cell movement provided with arrow keys 17 in the conventional remote control device 10 (FIG. 1). Furthermore, a complete set of telephone style alphanumeric buttons 218 are included or replace numeric buttons 18 for simple text and numeric entry. Alternatively, a complete set of virtual or physical keyboard style keys/buttons can be added to or replace the telephone style alphanumeric buttons 218. Therefore, a user can enter words, call letters and numbers.

The “GO” button 220 in addition to the conventional “MENU/SELECT” button 212 differentiates the selection command from GO to fetch/record command, such that multiple selections can be made before commanding the system to GO fetch multiple selections. In other words, the present invention allows the user to give a “list” of commands to be executed in an orderly fashion, instead of executing one command at a time, and wait for the execution before entering another command.

Referring also to FIG. 14B, a virtual on-screen control device 200′ is shown. The virtual on-screen control device 200′ is similar to hand-held remote control device 200 except it is virtual and displayed on the display 706 with the IAEPG guide-menu 250′. The virtual on-screen control device 200′ includes a “GO” button 220′ and a roll-ball “mouse” device 230′ that moves the highlight-cursor in any and all desired direction. Furthermore, a complete set of telephone style alphanumeric buttons 218′ are included for simple text and numeric entry. The virtual on-screen control device 200′ also includes the conventional control keys such as without limitation for operating a VCR. Thus, no further description is necessary.

Referring now to FIGS. 8A and 8B, an exemplary embodiment of an interactive electronic program/content guide (IAECG or IAEPG) of the present invention includes a guide-menu 100 that adds in the first horizontal row 102 a program/network entering box 106 and a virtual “GO” button 104. The program/network entering box 106 allows the user to enter a desired program name, a network (such as FOX or NBC, which often has multiple channels) or a list of channel numbers. After data entry is completed in program/network entering box 106, the “GO” button 104 is “clicked” to execute the retrieval of the program information related to the request data entered in program/network entering box 106. In the preferred embodiment, the IAEPG conducts a search for a program name(s), a channel name (or a list of movie or theater names in a movie/theater guide, or station name(s) in a train/bus guide) entered. The search results identify the program(s), channel(s) (or theater/station name(s)) that closely matches that which was entered.

The guide-menu 100 displays a list of the scheduled programs of search results, such as the channels-time list of the program titles entered, or the channel-time list of the networks entered, or the channel-time list of programs that are played at the corresponding channel-time of the list of channel numbers entered. In the exemplary embodiment, the list of the scheduled programs may be listed by day, week or month, or any reasonable specifications of time durations.

Similar to the conventional “guides”, the IAEPG grid-format guide-menu 100 of the present invention includes a first vertical column 126 to indicate the channel numbers and/or letters for the names of the Networks/enterprises associated with the channel numbers. Moreover, the IAEPG guide-menu 100 includes program title cells 128 indicating the program names that are played at the corresponding times as indicated by the second horizontal row 124, and on the corresponding channels as indicated by the first column 126.

Additionally, the grid-guide menu 100 adds a pull-down, multi-level, nested cascading menu row 108. The multi-level, nested cascading menu row 108 includes (a) “NEXT SCREEN” box 110 to “page down” to the next set of channels; (b) “THEME” box 112 to pull-down on-demand or enter multi-level themes/categories in nested, cascading structure and corresponding mechanisms to select a theme (or themes) from the structure; (c) “TIME” box 114 to pull-down a list or enter the time period selections, and a corresponding mechanism to select; (d) “SELECTION FOLDERS” box 116 to program, store or recall selections in organized folders; and (e) “CHANNEL LISTS” box 118 to list or enter the network services available, a friendlier way to facilitate the Channel Lists 34b and Channel Groups 34c functions in FIG. 3 of the prior-art. Alternately, these two pull-down menu slots can be used for other purposes. Additional pull-down menu slots can be added to facilitate additional functions. The pull-down, multilevel, nested cascading menu row 108 includes (f) “CHANNEL GROUPS” box 120 to program or a list channel grouping.

Additionally, the grid-guide menu 100 includes hidden “on”-demand annotations to explain to the users the cryptic terms used to notate various functional boxes and the program names on the menu.

Referring now to FIG. 8C, when the highlight/cursor is moved onto the cryptic term “NORMAL” 101 in the first horizontal row 102, a dialog box 101a appears to explain that the term “NORMAL” 101 and/or indicate a particular scheme. A scheme determines what programs are listed in which manner. Dialog box 101a displays other parallel listing options, which include: Normal, Scheme 1, Scheme 2, Scheme 3, etc. All terms used on the screen can be thus annotated.

Referring now to FIG. 8B, the “TIME” pull-down, multi-level, nested menu 130 for the “TIME” box 114 overlays the existing program listing and grid-guide menu 100 in the background. This previous program listing in the background is irrelevant to the user during his attempt to specify a new time period (or other parameters) for a new program listing. Thus, the background can be erased, as shown in FIG. 8D, and the freed screen space used for displaying advertising A, promotions, breaking news, or any other information B and C that might catch the users' attention.

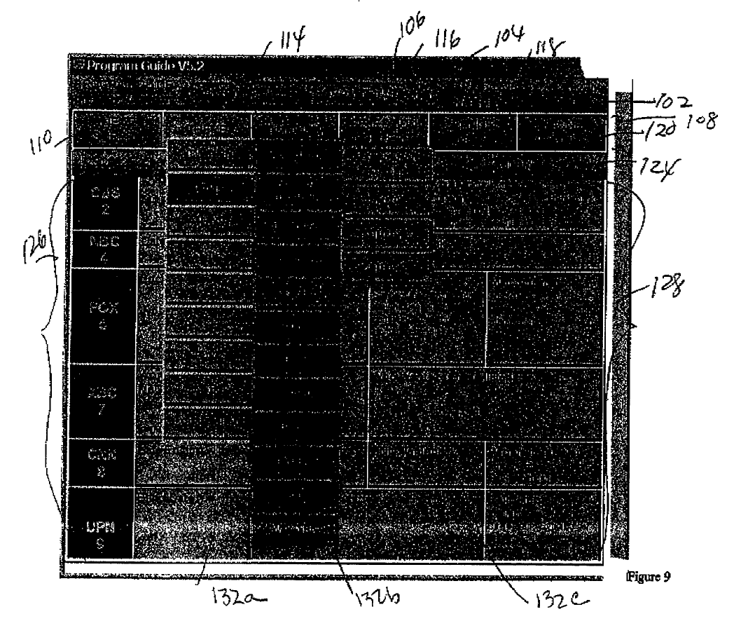

The pull-down, multi-level, nested menu 130 for the “TIME” box 114 displays a plurality of available selections of time windows and a data entry box for entering a particular time window. For example, selecting the “Now−2 Days” in menu 130, then pull-down the THEME pull-down menu 132a (FIG. 9) to select the MOVIE theme, and “click” the virtual GO button 104, would bring the list of movie programs for now through the 4th day to the display 706. The options programmed in this example include: programs scheduled from the present up to 8 hours from the present, the present up to 24 hours from the present, the present up to 2 days from the present, the present up to 4 days from the present, the present week's scheduled programming, or the next weeks programming, etc. After selecting the desired time window and the desired program theme, the user can press the REC button 221 to command the system 700 (FIG. 7) to commence recording programs in the selected theme category during the selected time window.

Referring now to FIG. 9, the on-demand, multi-level, nested cascading THEME-menu structure is shown. As can be appreciated, since there are numerous selection criteria, description of each selection criteria in the multilevel, nested cascading menu structure is prohibitive. In operation, when the “cursor” is moved to the “THEME” box 112 in the multi-level, nested cascading menu row 108, a pull-down menu 132a appears, giving generally useful themes for the user to choose from, such as MOVIES, NEWS, SERIES, SHOPPING, etc., Also contained in the THEME pull-down menu 132a is a dialog box labeled “NEW THEME,” that allows viewer to enter a specific theme name or to select from a given theme list in the first level “THEME” pull-down menu 132a. Other “Theme” categories may be used, added, included and listed.

To illustrate the multi-level capability of the guide-menu of this invention, in an exemplary embodiment as shown in FIG. 9, the viewer moves the “cursor” to “MOVIES,” for example, to indicate his/her interest in seeing the “Movies” listing. Thereafter, a next-level menu 132b appears to list the categories of movies, along with a dialog box labeled “ENTER MOVIES” to allow the user to either select a given category, enter a (or a list of) category name, or enter a movie (or a list of movies) name. The on-demand, multi-level, nested cascading menu structure provides the next-level or second-level, nested menu 132b, identifying a list of categories of “Movies,” such as, without limitation: the “All Movies,” “Action/Adventure,” “Children,” “Comedy,” “Drama,” “Fantasy,” “Horror,” “Musical,” “Romance,” “Sci-fi,” and “Western.” Nevertheless, other “Movie” categories may be included and listed.

A third-level, nested menu 132c appears as the viewer moves the “cursor” to select a category such as the “Movie” category from the second-level, menu 132b. Thereafter, the third-level selection options pop up in a menu 132c, as shown in the MOVIES—Comedy—Comedy 2 path. The names of types of comedy, such as Bill Crosby, Billy Crystal, Monty Python . . . etc. can be used instead of the Comedy 1, Comedy 2, Comedy 3 example used in the selection sequence. The viewer can press the MENU/SELECT button 212 on the control device 200 to fix the selection at any level. If the viewer intended to view the program list at the current time interval selection, the viewer merely presses a “GO” button 220 on the control device 200, or shift (move) the “cursor” to the virtual “GO” button 104 on the first horizontal row 102 of the grid-guide menu 100 and then presses the MENU/SELECT button 212 on the control device 200. Otherwise, after (or before) the theme selection the viewer can move the cursor to the “TIME” box 114 next to the “THEME” box 112 to make the time period option selection, as shown in FIG. 8B or 8D. Thus, during navigation, within any one of the multiple-level nested cascading menus, a nested, cascading category-tree of submenus appear and are overlaid upon the current page of the grid-guide menu 100, until the nested, cascading category-tree is exhausted, or the MENU/SELECT button 212 is pressed on remote control device 200. Nevertheless, other user input devices 710 can be used. Input devices may include a mouse, a point-and-click device, a screen pen, or a light pen input device.

The background start-up listing can be erased at the beginning of a selection process for a different listing, or at any time during the process, to make space for displaying advertisements A or other information B and C, as shown in FIG. 8D. Moving the “cursor” to the “ALL/NOW” at the left side of the first horizontal row 102 would bring back the default display option of the IAEPG. The default program listing is the “ALL PROGRAMS” listing for the “NOW PLUS 2 HOURS” time period.

After the viewer selects a particular subcategory, such as “Comedy 2” shown in FIG. 9 by clicking/pressing the “MENU/SELECT” button 212 on a control device 200 to fix the selection, the pull-down menus 132a, 132b and 132c would be erased, and the viewer proceeds to pull-down another menu item, such as TIME menu 130 via TIME box 114, as best seen in FIG. 8B. Alternatively, the “THEME” pull-down menus 132a, 132b and 132c can stay on the screen, while the TIME menu overlays the THEME menus. As a still further option, the display 706 can display the listing of all Comedy 2 movies for the “NOW PLUS 2 HOURS” time period, while the viewer proceeds to enter or select the time of interest by moving the “cursor” to the “TIME” box 114.

In an alternate embodiment, the “THEME” pull-down menus 132a, 132b and 132c remain on the IAEPG menu 100. When the cursor is moved to the “TIME” box 114, the “TIME” menu 130 is overlaid on the “THEME” pull-down menus 132a, 132b and 132c, especially, menu 132b directly below to the “TIME” box 114, and can be “clicked” back into view by clicking the “right arrow” next to the MOVIES category in menu 132a.

After entering or selecting a desired time-period from menu 130, the viewer can proceed to press the “GO” button 220 or the virtual “GO” button 104, at this point, to view the listing for the specified theme and time period. In the exemplary embodiment, “This Week” was selected.

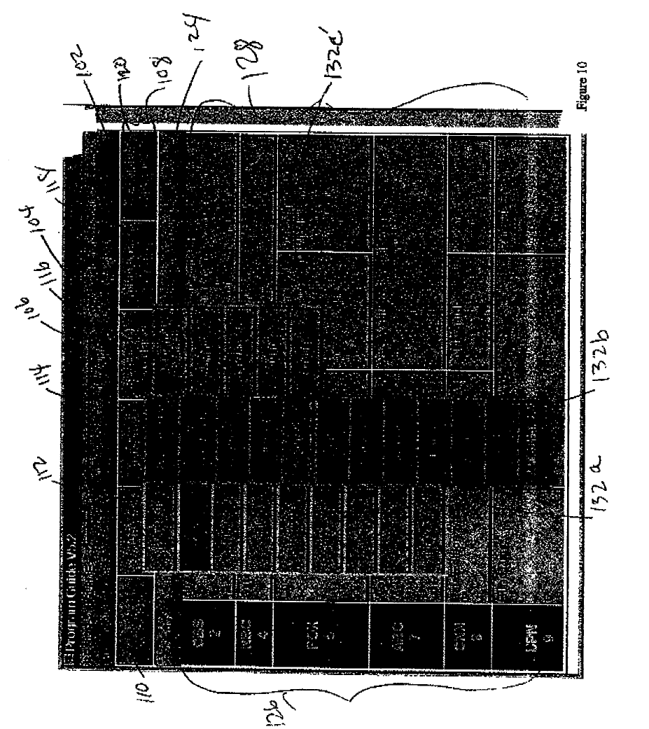

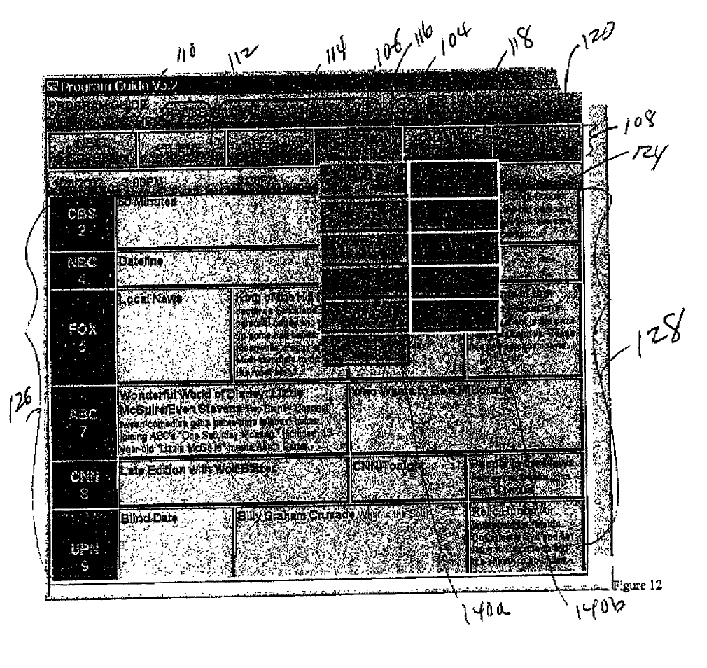

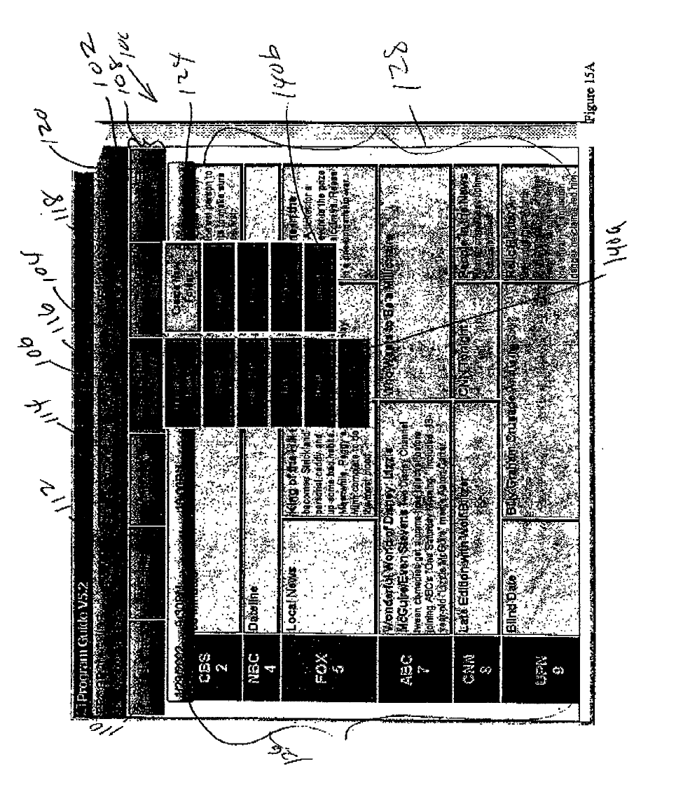

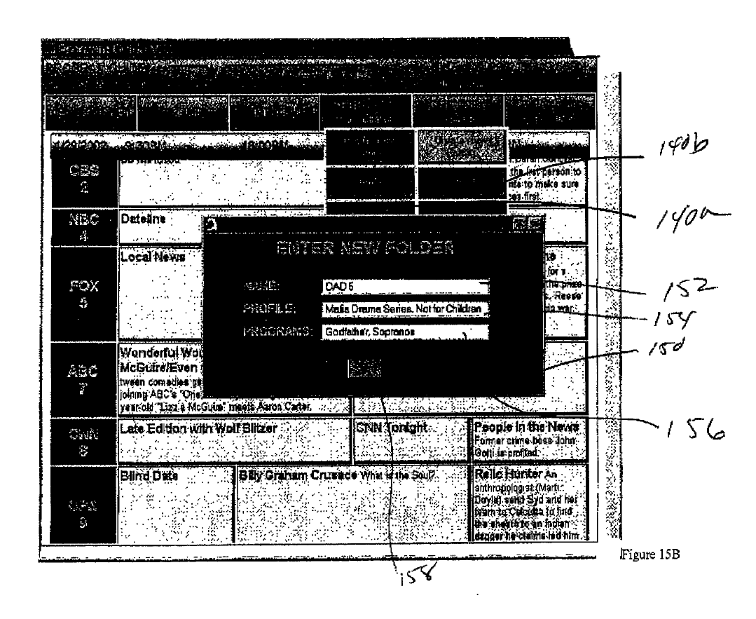

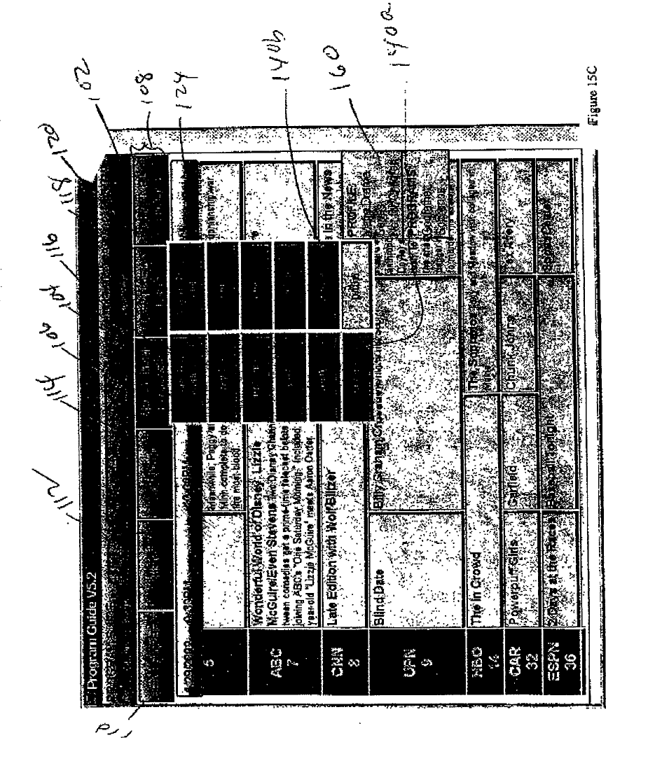

Referring now to FIG. 10, aLternately, in lieu of selecting the “GO” button 220 or the virtual “GO” button 104, the viewer can proceed to store the selection into a folder/file by moving the “cursor” to the next box (SELECTION FOLDERS 116) in the multi-level, nested cascading menu row 108. In this exemplary embodiment, folder Comedy 4 is established and added to the third-level, nested menu 132c′. A sequence to establishing a folder will be described in relation to FIGS. 12 and 15A-15C.

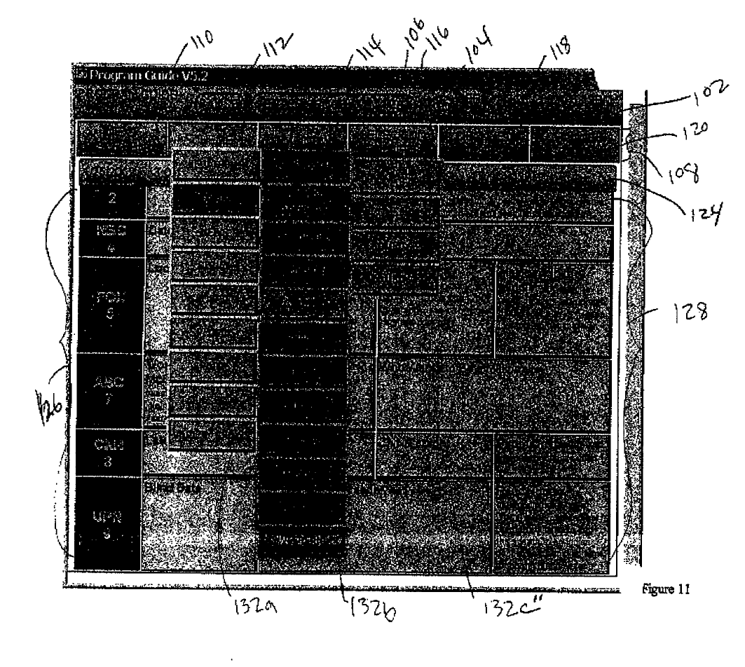

FIG. 11 illustrates the deletion of a folder or file that is no longer desired. Hence, the third-level, nested menu 132c′ illustrates the removal of folder Comedy 2. Accordingly, the menus are dynamic and can be programmed as desired by the user.

Referring now to FIG. 12, when the “cursor” is moved to the “SELECTION FOLDERS” box 116 the mechanism “CREATE NEW FOLDER” for setting-up a new folder/file appears along with a list of existing folders in a “SELECTION FOLDERS” pull-down multi-level, nested menu 140a. In the exemplary embodiment, the “SELECTION FOLDERS” pull-down multi-level, nested menu 140a includes lines or boxes titled “Mom,” “Dad,” “Sister,” “Brother,” and “Baby,” representing folders containing each family member's selection profile. When the “cursor” is moved to one of the lines or boxes of the first-level folders menu 140a, the next-level menu 140b is displayed. The next-level menu 140b includes at least one folder or file under a folder in the first-level menu 140a. In the exemplary embodiment, the “Dad” folder of menu 140a has four secondary selection-profile folders from which to select in the menu 140b. The folder/file contents are stored in the storage disks 726 in FIG. 7. When storing, the user can press the REC key 221.

The operation of the user profiles will now be described. FIG. 12 illustrates an exemplary “SELECTION FOLDERS” multi-level, nested cascading menu of the present invention to facilitate fast selection process. In this example, DAD's favorite program titles stored in DAD 1 folder will be shown in the subsequent program listing, and maybe subsequently selectively or entirely ordered to be recorded during “this week;” as “This Week” in the TIME menu 114 (FIG. 8B or 8D) is highlighted, and DAD 1 in 140b is highlighted/selected.

In view of the forgoing, the user can select programs using multiple criteria within one single process cycle so that during navigation the user does not have to return to the start-up page and retrace the steps one-selection-at-a-time. Instead, the functionalities of the multi-level, nested cascading menu structure 108 allows users to select multiple programs during one selection process cycle for recording, later viewing on demand, or later review of the selections. For example, the user can select multiple sets of selected programs under separate “folders” and “files” for recording and/or accessing and reviewing under such separate “folders” and files. Furthermore, the user can store multiple sets of selected programs under separate “folders” and “files” for recording and/or accessing and reviewing.

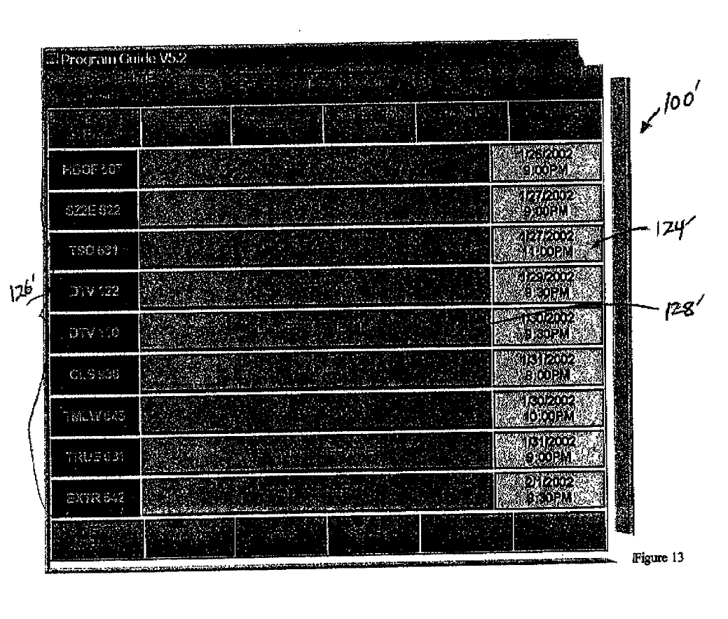

Referring again to FIG. 13, the IAEPG grid-guide menu 100′ displays the listing of Movies with the Comedy 2 category for the time window of the current week, in accordance with the user's selection criteria described in relation to FIGS. 9 and 10. As can be appreciated, grid-guide menu 100′ is different from the default option. From the grid-guide menu 100′, by highlighting multiple selections S1, S2, S3 and S4 on a program listing of the grid-guide menu 100′, a viewer can store the selection in a folder/file identified or established in the “SELECTION FOLDERS” box 116 and request recording of the selected programs for viewing on-demand at a later time.

The IAEPG grid-guide menu 100′ includes a first vertical column 126′ that indicates the channel numbers and/or letters. In lieu of a second horizontal row 124 that displays the corresponding time for a particular program(s), the time is shown in a third vertical column 124′. Moreover, the IAEPG grid-guide menu 100′ arranges the program title cells indicating the program name in a second vertical column 128′. In general the three columns 126′, 128′ and 124′ display for each row the channel name or number, the program title and corresponding time to permit multiple row selectivity wherein each row corresponds to a program.

FIG. 13 illustrates a user specified program listing that lists the Comedy2 programs profiled in the Comedy2 folder, during “This Week.” The program list allows users to select multiple items on the list and query and/or activate for their presentation or recording. The IAEPG grid-guide menu 100′ further includes a row of virtual buttons labeled “MOVIE”, “NEWS”, “SPORTS,” “ALL,” and “SORT” as in the conventional EPG. These virtual buttons allow the user to quickly access other common categories finished selecting from the programs listing shown.

Referring now to FIGS. 15A-C, the sequence for creating a folder will now be described. A folder can be created in the first and second-level menus 140a and 140b. As described previously, when the DAD listing is selected in the first-level menu 140a, the folders associated therewith are displayed along with “CREATE NEW FOLDER” line or box. In FIG. 15A there are displayed four DAD files or folders, (e.g. DAD 1, DAD 2, DAD 3, DAD 4). To created the DAD 5 file or folder, as best seen in FIG. 15C, the “CREATE NEW FOLDER” is selected in menu 140b. Thereafter, a window 150 is displayed to label and create the new file or folder DAD 5 with the programmable and dynamic program profile.

Window 150 is overlaid on the menus 140a and 140b. The window 150 includes a name data entry field 152 for entering a name to label the file or folder. The window 150 further includes a profile data entry field 154 for establishing the profile from which MEDIA or schedules programming is selected. In the exemplary embodiment, mafia drama series is the programmed profile. Nevertheless, other profiles can be used, such as comedy or other terms associated with tags identified in the MEDIA. The window 150 also includes a programs data entry field 156 that identifies various programs of interest. In the exemplary embodiment, the programs of interest include Godfather and Sopranos. The send button 158 creates or stores the file or folder in accordance with the profile and/or programs identified.

As shown in FIG. 15C, after the folder is created, if the user does not remember which folder has a particular pre-established profile or programs, highlighting the file or folder, such as DAD 5, displays a dialog box or widow 160. Such dialog box or window 160 identifies the profile or program. Therefore, when the folder is selected such as by pressing the virtual GO 104, the IAEPG guide-menu will display those channels and programs that meet the profile and/or program of such folder. Thus, system 700 would intercept those programs or MEDIA meeting the profile and/or program associated with the file when selected. By selecting the DAD 5 file or folder via a single command, the system 700 fetches at least one and preferably multiple programs associated with the profile or programs identified.

Storing multiple profiles via multiple folders allows for immediate and quick display of those channels and programs of interest from the many channels provided.

### SUMMARY

As can be readily seen, the present invention significantly provides more program-guide clarity, selection flexibility, immediacy, simplicity, and user process efficiency, reduces the difficulties and complexity of using a program guide and programming a recording device or a view-on-demand order. The present invention also provides user preference tracking/recording in an organized manner.

The present invention includes a system 700 that can be used for any interactive/active electronic program/content guides (IAECG or IAEPG) for systems that list, present, and distribute media, scheduled programming, products, services, and information (MEDIA). Some examples of these systems are broadcast TV, satellite TV, or cable TV systems, movie theaters, video repositories, game repositories, theaters, musicals, shopping, restaurant, and any directory services that are broadcast in a wired or wireless manner.

The system 700 intercepts the MEDIA, wraps the MEDIA with a Web-like interface, and performs intelligent, automated go-between tasks for the user in probing and retrieving from the MEDIA or the CONTENT that suits individual user's specifications, preferences, and profile(s). The system 700 of the present invention can be used to list, categorize, browse, record and store multiple user preferences and profiles for a multitude of users, and make simultaneous multiple selections. The system 700 also facilitates the issuing of simultaneous commands to selectively retrieve, record, or purchase desired CONTENT from the MEDIA. The display device can be TV, electronic displays at airport terminals and department stores, cell-phones, Kiosks, and computer displays.

Moreover, the IAEPG or IAECG can be used for train stations guides, theater guides, etc.

Numerous modifications to and alternative embodiments of the present invention will be apparent to those skilled in the art in view of the foregoing description. Accordingly, this description is to be construed as illustrative only and is for the purpose of teaching those skilled in the art the best mode of carrying out the invention. Details of the structure may be varied substantially without departing from the spirit of the invention and the exclusive use of all modifications which come within the scope of the appended claims is reserved.

What is claimed is:

1. An interactive broadcast system, comprising:
an interactive electronic program guide (EPG) having a grid-guide menu identifying programs and at least one multiple-level nested cascading menu adapted to be overlaid upon a current page of the grid-guide menu; and
a control device for navigating within the grid-guide menu and the at least one multiple-level nested cascading menu.

2. The system according to claim 1, wherein during navigation, within the at least one multiple-level nested cascading menu, a nested, cascading category-tree of submenus appear and are overlaid upon the current page of the grid-guide menu until the nested, cascading category-tree is exhausted.

3. The system according to claim 1, further comprising:
means for entering a program name; and
means for searching and identifying programs that closely match the entered program name, and listing a channel station name and show time for each of these programs found via the grid-guide menu.

4. The system according to claim 1, wherein the EPG further comprises:
a pull-down menu for selecting one of a plurality of time windows, each time window having a different time duration; and
means for controlling the grid-guide menu to list a program schedule of the channels for the selected time window.

5. The system according to claim 1, further comprising means for intercepting multiple programs selected from a single grid-guide menu display for recording, later viewing on demand or later review of selections.

6. The system according to claim 5, wherein the control device includes:
means for selecting the multiple programs during a single selection sequence; and
means for fetching the selected multiple programs selected during the single selection sequence for recording, later viewing on demand, or later review of the selections.

7. The system according to claim 1, further comprising:
means for creating folders via the at least one multiple-level nested cascading menu, each folder having at least one file wherein each file has a programmable program profile; and
means for acquiring and identifying via the EPG those programs related to the programmable program profile.

8. The system according to claim 1, further comprising means for listing the programs under a selected category or theme sequentially for a specified time period.

9. The system according to claim 1, further comprising means for storing a user profile in a folder or file for later access, review, view-on-demand, or recording.

10. The system according to claim 1, further comprising a pointing cursor to navigate through the EPG.

11. The system according to claim 1, further comprising alphanumeric keys for alphanumeric data and request entry.

12. The system according to claim 11, wherein the control device further comprising a MENU/SELECT button to effectuate a selection command, and a GO button to effectuate a fetch command of the selection command.

13. The system according to claim 12, wherein the fetch command activates fetching of multiple selection commands from a current grid-guide menu.

14. The system according to claim 11, wherein the control device is virtual and displayed in combination with the EPG.

15. The system according to claim 11, further comprising means for selecting multiple sets of selected programs under separate folders or files for recording, accessing or reviewing.

16. An interactive media computing and communication system, comprising:
a display; and
an interactive electronic content guide (ECG) displayed on the display having a grid-guide menu identifying broadcast content and at least one multiple-level nested cascading menu adapted to be overlaid upon a current page of the grid-guide menu.

17. The system according to claim 16, wherein during navigation, within the at least one multiple-level nested cascading menu, a nested, cascading category-tree of submenus appear and are overlaid upon the current page of the grid-guide menu, until the nested, cascading category-tree is exhausted.

18. The system according to claim 16, wherein the ECG further comprises:
means for entering a program name; and
means for searching and identifying programs that closely matches the entered program name, and list that channel station name and show time for each of these programs found via the grid-guide menu.

19. The system according to claim 16, wherein the ECG further comprises:
a pull-down menu for selecting one of a plurality of time windows, each time window having a different time duration; and
means for controlling the grid-guide menu to list a schedule of the broadcast content for the selected time window.

20. The system according to claim 16, further comprising means for intercepting multiple programs of the broadcast content selected from a single grid-guide menu display for recording, later viewing on demand or later review of selections.

21. The system according to claim 20, further comprising:
means for navigating within the grid-guide menu and the at least one multiple-level nested cascading menu, the navigating means includes:
means for selecting multiple programs of the broadcast content during a single selection sequence; and
means for fetching the selected multiple programs selected during the single selection sequence for recording, later viewing on demand, or later review of the selections.

22. The system according to claim 16, further comprising:
means for creating folders via the at least one multiple-level nested cascading menu, each folder having at least one file wherein each file has a programmable content profile; and
means for identifying via the ECG the broadcast content related to the programmable content profile.

23. The system according to claim 16, wherein the ECG further comprises means for listing the broadcast content under a selected category or theme sequentially for a specified time period.

24. The system according to claim 16, wherein the ECG further comprises:
means for storing a user profile in a folder or file for later access, review, view-on-demand, or recording;
means for intercepting broadcast content related to the user profile; and
means for listing or presenting the intercepted broadcast content.

25. The system according to claim 16, wherein the ECG further comprises a pointing cursor to navigate through the ECG.

26. The system according to claim 16, further comprising means for navigating within the grid-guide menu and the at least one multiple-level nested cascading menu, wherein the navigating means includes alphanumeric keys for alphanumeric data and request entry.

27. The system according to claim 26, wherein the navigating means further includes:
a MENU/SELECT button to effectuate a selection command; and
a GO button to effectuate a fetch command of the selection command.

28. The system according to claim 27, wherein the fetch command activates fetching of multiple selection commands from a current grid-guide menu.

29. The system according to claim 27, wherein the navigating means is virtual and displayed in combination with the ECG.

30. The system according to claim 27, wherein the navigating means includes a rollball to move a cursor on the display to a desired cell of the grid-guide menu in a direct shortest-path motion.

31. The system according to claim 27, further comprising means for selecting multiple sets of selected broadcast content under separate folders or files for recording, accessing or reviewing.

32. The system according to claim 16, wherein:
the display is a TV screen;
the system is integrated into or interfaced with a TV; and
the broadcast content is wired or wireless via cable systems, satellite systems, or the Internet.

33. The system according to claim 16, wherein:
the display is a computer display, a Kiosk display, cell-phone display or other electronic display terminal;
the system is integrated into or interfaced with a computer; and
the broadcast content is wired or wireless via cable system, satellite system or the Internet.

34. A control device for interfacing with a display, comprising:
a rollball to move a cursor on the display to a desired cell in a direct shortest-path motion; and
alphanumeric buttons for entering alphabetic and numeric entries on the display.

35. The device according to claim 34, further comprising:
a MENU/SELECT button to effectuate a selection command; and
a GO button to effectuate a fetch command of the selection command.

36. The device according to claim 35, wherein the control device is a hand-held remote control device.

37. The device according to claim 35, wherein the control device is a virtual control device displayed on the display.

38. The device according to claim 35, further comprising:
channel up and down keys for selecting a program channel;
a GUIDE button for displaying a electronic programming guide menu; and
VCR control buttons including a record button.
